(19) United States
(12) Patent Application Publication
(10) Pub. No.: US 2010/0017218 A1
(43) Pub. Date: Jan. 21, 2010

(54) BUSINESS METHOD FOR DOMAIN NAME AND TRADE MARK ASSIGNING AND MARKETING

(75) Inventors: Marina Gazetova, Visaginas (LT); Liudmila Gazetova, Visaginas (LT); Rafael Gazetov, Visaginas (LT)

Correspondence Address: YOUNG & THOMPSON, 209 Madison Street, Suite 500, Alexandria, VA, 22314, US

(73) Assignee: UAB "IEEC", Vilnius (LT)

(21) Appl. No.: 12/176,476

(22) Filed: Jul. 21, 2008

(51) Int. Cl. G06Q 99/00

(52) U.S. Cl. 705/1

(57) ABSTRACT

The business method for domain name and trade mark assigning and marketing is performed by a person or legal entity by assigning a domain name (URL) in domain fields, which is identical, similar in pronunciation, or in writing, or in other ways, up to complete confusion, to a trade mark, company name, field of activity, brand, key word, popular word, geographical or filed name, personal name, family name, pseudonym and/or other person's or legal entity's attributes which belong to another person or legal entity; or by assigning a trade name, brand, company name, and/or other person's or legal entity's attributes, which are identical, similar in pronunciation, or in writing, or in other ways, up to complete confusion, to a domain name (URL) which belongs to another person or legal entity.

### FIELD OF THE INVENTION

The present invention is an important legal part of the complex global way of solving the problem of cybersquatting and typesquatting.

The present invention is a global and effective way of organizing a civilized Internet market of domain names, which allows putting cybersquatting and typesquatting into civilized channel, and covering the legal field of the Internet market in whole.

The present invention relates to Internet based technologies, and its purpose is to protect users from cybersquatters and typesquatters.

The present invention is a global and effective way of organizing a civilized domains' market, as far as cybersquatting and typesquatting are acknowledged to be a real global threat to the Internet, and legal protection of users from cybersquatters and typesquatters can be effective only if it becomes international, however, the process of passing a universal anti-squatting law in all countries of the world community is a long and complicated one.

The present invention is an important legal part of the complex global way of solving the problem of cybersquatting and typesquatting, which are being struggled against on legal, technological, and social levels; it will provide effective means against cybersquatting and typesquatting with minimization of its volumes; and it is an important element of supporting favorable conditions for use of the global network Internet and ensuring preservation of its entirety.

The present invention allows purposive application of patent laws against cybersquatters and typesquatters who brake the law, as well as coordination of activities within IT industry, it also allows to expand the field of struggle against cybersquatters and typesquatters, and it helps to find compromise between extremely stringent and too mild laws.

### BACKGROUND

In the present invention, cybersquatting is registering, trafficking in, or using a domain name with bad-faith intent to profit from the goodwill of a trademark belonging to someone else. The cybersquatter then offers to sell the domain to a person or company who owns a trademark contained within the name at an inflated price.

In the present invention, cybersquatting is a bit different in that the domain names that are being “squatted” are (sometimes but not always) being paid for through the registration process by the cybersquatters.

In the present invention, the domain name and the trade mark are independent objects of civil law, this is why the problem of relating domain names to objects of intellectual property is an acute one. With the development of the Internet, the domain name, being a friendly identifier of the computer address in the Internet, is an identifier of the field of activity, products and services at the same time, and it gets more and more related to business demands and information placed on the given address.

In the present invention, unlawful use of a trade mark, company name, or other person's or legal entity's attributes in the domain name brakes the exclusive rights and makes harm to the legal owner.

In the present invention, cybersquatters usually ask for prices far greater than that at which they purchased it. Some cybersquatters put up derogatory remarks about the person or company the domain name is meant to represent in an effort to encourage the subject to buy the domain name from them. Others post paid links for example, via Google, Yahoo, Ask.com and other paid advertising networks to the actual site that the user likely wanted, thus monetizing their squatting. As with many controversial issues, some argue that the dividing line of cybersquatting is difficult to draw, or that the practice is consistent with a capitalistic and free market ethos.

In the present invention, cybersquatting, as a process of capturing free domain names for further re-sale, has become part of virtual economic entertainment, because domain zone administrators, being responsible for technical “domain name assigning”, take fixed registration fees for domain name assigning. This fee is small and it does not depend on the type of the domain name. Having bought a domain with a “tasteful” name, for example, oil.com, avto.ru, a cybersquatter puts it on sale for a price which is much higher than the registration fee was.

### SUMMARY OF THE INVENTION

In the present invention, business method for domain name and trade mark assigning and marketing is performed by a person or legal entity by assigning, re-assigning, or buying a domain name (URL) in domain zones, which is identical, similar in pronunciation, or in writing, or in other sound or visual characteristics, up to complete confusion, to a trade mark, company name or field of activity, brand, key word or popular word, geographical or field name, personal name, family name, pseudonym, and/or other person's or legal entity's attributes which belong to another person or legal entity; or by assigning or buying a trade mark, brand, company name, and/or other person's or legal entity's attributes, which are identical, similar in pronunciation, or in writing, or in other characteristics, up to complete confusion, to a domain name (URL) which belongs to another person or legal entity, with the purpose of further sale of assigned domain names or their unconscientious use.

In the present invention, business method for domain name and trade mark assigning and marketing is performed by a person or legal entity by assigning, re-assigning, or buying in existing domain zones a domain name (URL), or other means of individualizing of persons or legal entities, as well as their products and services in the form of a trade mark, brand, company name or field of activity, key word or popular word, personal name, family name, pseudonym, and/or other person's or legal entity's attributes; or by assigning, or buying a trade mark, brand, company name or field of activity, key word or popular word, personal name, family name, pseudonym, and/or other person's or legal entity's attributes in the form of a domain name or other means of individualizing of persons or legal entities, as well as their products and services.

In the present invention, business method for domain name and trade mark assigning and marketing is performed by a person or legal entity by assigning or re-assigning a domain name (URL), which has been registered in a top level domain zones, for example, in the domain zone COM, in other international or national top level domain zones, for example, top level domain zones NET, ORG, GOV, EDU, MIL, BIZ, INFO, PRO, TV, US, RU, DE, FR.

In the present invention, a person or legal entity can assign or re-assign domain names (URL) in other top level domain zones, for example, evergraf.net, evergraf.org, evergraf.gov, evergraf.us, etc., which are identical, similar in pronunciation or writing, or in other ways, up to complete confusion, to the domain name that has already been registered in a certain top level domain zone, for example, evergraf.com.

In the present invention, owning a domain name in any top level domain zone is a basis for acquiring rights for the same or similar domain names in other top level domain zones.

In the present invention, business method for domain name and trade mark assigning and marketing is performed by a person or legal entity by assigning, re-assigning, or buying a domain name (URL) in existing domain zones in all variations of its spelling, which is identical, similar in pronunciation or in writing, or in other sound or visual characteristics, up to complete confusion, to a trade mark, brand, company name or field of activity, key word or popular word, personal name, family name, pseudonym, and/or other person's or legal entity's attributes which belong to another person or legal entity; and by further demand for transferring the right of ownership and administration of this trade mark, brand, company name or field of activity, key word or popular word, personal name, family name, pseudonym, and/or other person's or legal entity's attributes, for example, by going to arbitration and court (direct domain hijacking).

In the present invention, business method for domain name and trade mark assigning and marketing is performed by a person or legal entity by assigning, re-assigning, or buying a domain name which is identical, similar in pronunciation or in writing, or in other sound or visual characteristics, up to complete confusion, to a trade mark, brand, company name or field of activity, key word or popular word, personal name, family name, pseudonym, and/or other person's or legal entity's attributes which belong to another person or legal entity (having the right of ownership), for unconscientious use of the domain name, for example, in order to improve own competitive status, or to hinder the right owners from conducting their activity, or to do some harm to the right owners in commercial purposes, for example, in order to sell them further to the night owners, or to place advertisement, or to attract users to certain web-sites and thus increase web-traffic, or with other non-commercial purpose which is not related to improvement of competitive status (direct domain hijacking).

In the present invention, business method for domain name and trade mark assigning and marketing is performed by a domain name registrar by assigning or re-assigning of an available domain name on his own name with further transfer or sale of the domain name to other users, or transfer or sale of the domain name back to previous owner (direct domain hijacking).

In the present invention, procedure of domain registration does not hinder registrars from registering domains on their own names in order to re-sale them. This is why during an action time some registrars register a domain on their own names and then re-sale it to the winner for the sum pronounced at the auction. Formally it is a domain registration with further re-sale.

In the present invention, some registrars offer their clients a new type of services, and that is <<return of the domain name which the owner forgot to prolong>>. Such registrars can register all available clients' domain names on their own names and on such conditions that they can not be accused of cybersquatting. If during definite time, for example, three months, the client does not change his/her mind and take the domain name back for the fee equal to the first registration fee, the domain name becomes free for public registration. Registrars assign such domain names on their own names. Then the domain name is put on sale or transferred back to the previous owner. The domain name can be bought not only by the previous owner, but by any other client who applies for it. And in this case the registrar can use technical means for hindering ordinary participants of the market from legal opportunity of assigning an available domain name for a reasonable price and for setting the price which can be a few times bigger than the market price.

In the present invention, business method for domain name and trade mark assigning and marketing is performed by a person or legal entity by submitting single, multiple, or mass applications to one or several registrars for assigning available domain names for their further commercial use, for example, for personal gain, for placement of advertisement, attracting users and increase of web-traffic, for optimization of web-sites and placement of links to those web-sites which are being optimised, or for further re-sale or transfer to another person or legal entity, or for non-commercial use (direct domain hijacking).

In the present invention, business method for domain name and trade mark assigning and marketing is performed by a person or legal entity by distribution of phone, mail, or e-mail applications to registrars for assigning a domain name, with further registration of the requested domain name by the registrar on his own name and offer to sale or transfer it to another person or legal entity (direct domain hijacking).

In the present invention, business method for domain name and trade mark assigning and marketing is performed by a person or legal entity by assigning or re-assigning of a domain name, which has been requested by another person or legal entity for registration or check, for example, during entering the domain name in a whois service browser or during clicking on the banner which offers services on domain name check and requests feedback details, as well as offers re-sale or transfer of the registered domain name to another person or legal entity (direct domain hijacking).

In the present invention, business method for domain name and trade mark assigning and marketing is performed by a person or legal entity by single or periodic assigning or re-assigning of a domain name through different registrars, from different IP-addresses, networks and agreements, for example, for 5-days periods, with opportunity for periodic removal and further periodic registration, as well as periodic placement of advertisement, for example, pay-per-click advertisement, on this domain name in order to check profitability of this domain name (direct domain hijacking).

In the present invention, such “domain tasting” allows free of charge 5-days “trial” of a domain name and placement of pay-per-click advertisement on the domain name in order to check profitability of this domain name. If advertisement placement brings profit, the user can decide to leave the registered domain name. Otherwise, the domain name is removed and registration fee is compensated. Then the domain becomes available for assigning on any other name. This allows organizing a system where a user can remove the domain after a 5-days period and re-register it for another 5-days period through another registrar.

In the present invention, domain names are often possessed by so called “tasting” companies which register domain names in order to test them, i.e. to see whether they will be able to attract traffic. If there is no traffic, then after 5 days the domain name is “cast out” to the spaces of the Internet awaiting its new owner. And on the contrary, of the domain name becomes popular, then the “tasting” company keeps it in order to earn money from traffic with the help of PPC (“pay per click”) technology. Nowadays, a domain “taster” needs just a few minutes to intercept, analyze and assign a domain name which has been proposed by another user.

In the present invention, the algorithm of domain-taster actions is the following:
“the taster” registers a domain name and has 5 days for opportunity to cancel the registration and refuse the domain, having received the registration fee compensation, which he does in future;
then “the domain hunter” appears on the scene again and registers the domain name which he rejected a few days ago;
“the taster” opens a web-site again, waits for 5 more days, and refuses it again, having received the registration fee compensation; and this process can be repeated endlessly. Moreover, such strategy allows the domain name taster do not pay for the domain name at all, and at the same time get profit even from the least popular site: this is the money received from Pay Per Click payments.
Besides, every “hunter” may have thousands and even millions domain names which are constantly re-registered.

In the present invention, there is daily registration, re-registration, or buying of hundreds of new domain names, as well as daily removal of numerous domain names from the register. Some domain names are removed completely, and some—just in order to be re-registered again. Because some removed domain names have interesting names, at the moment of their removal from the register, cybersquatters send a huge number of requests for their interception.

In the present invention, a cybersquatter can work through different registrars simultaneously, moreover, he can have several agreements, both cooperation and client agreements, with each of them (usually the agreements are signed on the name of friends, relatives, or affiliated companies).

In the present invention, the domain name is not transferred into the site owner's unlimited use, and, moreover, his ownership. As a rule, the domain name is registered for one year. After the registration term expires, it needs to be prolonged. If the site owner does not do it on time, the domain name will become free and can become cybersquatter's possession. After the domain name registration term expires, the domain name is still reckoned after its previous owner for one more month. It can be prolonged during that period. But then it becomes free and can be registered on anyone's name. Some companies which decided to create their web-site, found out that the domain name that was the same as their company name or trademark, had been already taken by a person or legal entity, and for the domain name transfer they asked for the sum that was hundred and even thousand times bigger than the “official” registration fee. Domain name interception is possible because of missed payment and extension of the domain name registration, because after the domain name registration term expires, the domain name is still reckoned after its previous owner for one more month.

In the present invention, cybersquatters activity has the following distinct features:
Buying domain names which names contain popular company names and trademarks;
Buying domain names for further re-sale for a higher price;
Hijacking domain names by companies-competitors for creation of a web-site where false information about the competitor will be placed in order to bring it big losses.

In the present invention, there are the following indicators showing that the domain name belongs to cybersquatters, which are revealed after the domain name is entered in a browser's address line:
no server exists for this web-resource;
the web-site is under development;
the web-site is not related to the domain name;

In the present invention, there are three main types of domain names which are registered or bought by cybersquatters:
domain names which contain popular words defining certain concepts and fields of activity, for example, money, business, policy, etc.;
domain names which exactly or almost exactly coincide with names of economy fields, for example, oil.com, energy.com, etc.;
domain names which exactly or almost exactly coincide with to names of famous companies;
domain names which coincide with names and family names of famous people of nowadays and historic figures;
domain names which contain geographical names: countries, cities, regions, etc.

In the present invention, domain names which names are similar to popular words and not trademarks, for example, beer.com, medik.ru, business.com, halyava.ru, etc., cab be registered by anyone. And in this case no company that offers such products or services can do anything, because no legal rights and interests are infringed on.

In the present invention, conventional scheme of domain name “capture” is the following:
a user has come up with an “ideal” domain name;
an operational check with the help of Whois-server on a specialized web-site has proved that the domain name is still free for use;
due to some reasons, the user has postponed domain name registration for a few days;
when the user decides to continue the process and to finish domain name registration, it appears that the domain name has already been taken by someone.

In the present invention, access to search queries of Whois-server can be performed by using special software, for example viruses, or through fraudulent web-sites which provide opportunity for checking whether certain domain names are still available.

In the present invention, the main negative aspect of cybersquatting is that those who capture domain names know that there are persons who have pretensions to it and have rights for it. Besides, the registrar is not able to check applicant's purposes for registration. Even in case of farther re-sale of the domain name, it is difficult to suspect the first owner in cybersquatting. In the meanwhile, cybersquatters continue registering more and more domain names and take bigger and bigger niches in the Internet area on purpose, in order to re-sale domain names. It happens long before major events take place in the world and in business.

In the present invention, in each country has certain conditions for domain names registration. In some countries it is allowed to register only third, and not second, level domain names, for example, site.co.uk in Great Britain, or site.com.au in Australia. In some countries domain names registration in the national domain zone is allowed only for the residents of the country, in some countries there is another limit: domain names can be registered only by those who have their own trademarks.

In the present invention, cybersquatters use slow work of marketing departments and shortsightedness of the business community. They are hard to compete with, because it is business for them, when they constantly analyze information, world and business news, new trademarks, brands, re-branding, etc. Before the domain name registration takes place, a user is not capable of thinking through all details, and cybersquatters can quickly create a similar domain name or the one imitating the original domain name. Cybersquatters are professionals and use dictionaries, databases and even insider's information.

In the present invention, business method for domain name and trade mark assigning and marketing is performed by at least two persons or legal entities, possessing identical, similar in pronunciation or in writing, or in other sound or visual characteristics, up to complete confusion, trademarks, brands, company names or fields of activity, key words or popular words, personal names, family names, pseudonyms, and/or other person's or legal entity's attributes, which have been registered in different categories by assigning, re-assigning, or buying a domain name which is identical, similar in pronunciation, or in writing, or in other sound or visual characteristics, up to complete confusion, to an existing trade mark, company name or field of activity, brand, key word or popular word, geographical or field name, personal name, family name, pseudonym, and/or other person's or legal entity's attributes, with mutual use of the domain name and web-page division into separate parts, so that users can move from there to kinds of products and services they are interested in (reverse domain hijacking).

In the present invention, there are cases when owners of two identical trademarks which have been registered in different categories, can claim to possess a certain domain name. In this case, the domain name can be of mutual use, and the web-page can be divided into two parts, providing opportunity for further move to different products and services.

In the present invention, reverse domain name hijacking takes place when the trademark has priority over the domain name, i.e. the owner of the trade mark can forbid the use of his trademark in the domain name.

In the present invention, reverse domain name hijacking takes place when registration of a trademark, company name, or other person's or legal entity's attributes is a means of getting rights for a promoted and popular domain name. The owner of a trademark which is identical to the domain name, can demand for transferring the right of domain name administration to himself, and it is not important when the domain name was registered and used. For example, a user has registered a domain name user.com, and then he created and promoted a web-resource on this domain name. The web-site has big volumes of visits, it is known, popular, and quoted. And then appears a company which has recently registered a trademark User, and it has pretensions to the user that he has hijacked the domain name which the company has rights for. Such a case when the domain name was registered earlier than a corresponding trademark, and the trademark was registered just in order to take over the domain name using court procedures, is called reverse domain name hijacking.

In the present invention, according to law systems in many countries, the domain name is not a new object of exclusive rights, but it is included in the list of objects hindering from legal protection of trademarks, if they copy domain names which were registered before the trademarks. Here an opportunity for reverse domain name hijacking appears, i.e. capturing a domain name by registering a corresponding trademark and going to court. Many cybersquatters register trademarks just in order to obtain corresponding domain names through court. Reverse domain name hijacking is internationals, because national laws in most countries put the trademark higher than the domain name.

In the present invention, in some countries, for example, in Russia, the trade mark has total domination over the domain name. Factually it means that reverse domain name hijacking is legally possible and right in Russia. Thus, the domain name owner is always at risk of loosing the domain name if he is not the owner of the corresponding trademark as well.

In the present invention, business method for domain name and trade mark assigning and marketing is performed by a person or legal entity by assigning, re-assigning, or buying on his own name a trademark, brand, company name or field of activity, key word or popular word, personal name, family name, pseudonym, and/or other person's or legal entity's attributes, in different categories of products and services and in all variations of spelling, which are identical, similar in pronunciation, or in writing, or in other sound or visual characteristics, up to complete confusion, to a domain name (URL) which belongs to another person or legal entity, with further demand for transferring the right of ownership or administration of the domain name (URL), for example, by going to court or arbitration (reverse domain hijacking).

In the present invention, business method for domain name and trade mark assigning and marketing is performed by a person or legal entity by assigning, re-assigning, or buying on his own name a trademark, brand, company name or field of activity, key word or popular word, personal name, family name, pseudonym, and/or other person's or legal entity's attributes, in different categories of products and services and in all variations of spelling, which are identical, similar in pronunciation, or in writing, or in other sound or visual characteristics, up to complete confusion, to a domain name (URL) which is used conscientiously by the latter (reverse domain hijacking).

In the present invention, a short phrase which users associate with the domain name owner can be used as a domain name. This can be part of a company name or trademark for legal entities and a family name or pseudonym for persons. Persons or legal entities can register more general domain names, for example, car.com, sex.com, or their telephone numbers, for example, 7855555.com, or other names. Such users register domain names for their own use and are called conscientious.

In the present invention, characteristics of unconscientious use of the domain name are, at least, the following:
commercial gain from domain name administration
a discredit of identical, similar in pronunciation, or in writing, up to complete confusion, trademark, brand, company name or field of activity, key word or popular word, personal name, family name, pseudonym, and/or other person's or legal entity's attributes;
creation of false impression about the web-site's origin by distracting users' attention from the web-site that belongs to the trademark owner;
transfer or sale of a domain name by a trademark owner to another person or legal entity for their conscientious use in order to receive commercial gain;
submission of false information at the stage of domain name assigning or re-assigning, or non-submission of information when it is requested;
buying or assigning a certain number of domain names which are identical, similar in pronunciation, or in writing, to other trademarks, brands, company names or fields of activity, key words or popular words, personal names, family names pseudonyms, and/or other person's or legal entity's attributes;
domain name's dependence on the popularity level of a trademark, brand, company name or field of activity, key word or popular word, personal name, family name, pseudonym, and/or other person's or legal entity's attributes, which name is included in the domain name.

In the present invention, characteristics of conscientious use of the domain name are, at least, the following:
possessing approved intellectual property rights for the meaning used in the domain name;
legal name of a company or person that is used in the domain name, as well as its components, for example, abrams.com—part of the family name and the first letter of the name that form the pseudonym;
use of the domain name before, for example, for offering products or services;
non-commercial use of this name before on a web-site which is accessible through this domain name.

In the present invention, the purpose of domain name registration defines conscientiousness or unconscientiousness of the use of the domain name. In case when disputable domain name has been registered in order to hinder the owner of exclusive rights from conducting his activity, inadmissibility of misuse of the rights needs to be acknowledged. And in case when there are no signs of misuse of the rights, registration and use of the domain name which name coincides with another trademark is not considered to be violation of rights, according to UDRP conditions.

In the present invention, domain names which are similar to trade marks, company names, or other person's or legal entity's attributes, can also be used for criticizing offered products and services.

The present invention allows constant monitoring of the use of domain names which are associated with or similar, up to complete confusion, to trademarks, company names, or other person's or legal entity's attributes, as well as active protection of domain names which are important for personal and company business.

The present invention provides the right owner with additional opportunities for substantiating domain name administrator's unconscientiousness, for example, by proving that the respondent systematically registers domain names which use earlier registered trademarks.

In the present invention, a registered domain name and a corresponding trademark, brand, company name, key word or popular word, personal name, family name, pseudonym (direct domain hijacking).

In the present invention, a domain name is similar up to complete confusion, to a trade mark, brand, company name, personal name, family name, pseudonym, and/or other person's or legal entity's attributes, because of identical or similar transliteration of the domain name which is registered only in one language, for example, Russian (direct domain hijacking).

In the present invention, a domain name is similar up to complete confusion, to a trade mark, brand, company name, personal name, family name, pseudonym, and/or other person's or legal entity's attributes, because of a foreign word which is a copy of the domain name (direct domain hijacking).

In the present invention, a domain name is, at least, similar up to complete confusion, to a trade mark, brand, company name, personal name, family name, pseudonym, and/or other person's or legal entity's attributes, because, apart from the registered meaning, it includes any other sound, colour, graphic, or number and letter combinations, for example, those indicating the place of production or sale of products and services, products' make and model, products' types and categories, legal structure of the producer, consumers' categories (direct domain hijacking).

In the present invention, a domain name is, at least, similar up to complete confusion, to a trade mark, brand, company name, personal name, family name, pseudonym, and/or other person's or legal entity's attributes, because it copies a trade mark, brand, company name or field of activity, personal name, family name, pseudonym, and/or other person's or legal entity's attributes with deliberate spelling mistakes, for example, sport-expres.com instead of sport-express.com (direct domain hijacking).

In the present invention, business method for domain name and trade mark assigning and marketing is performed by a person or legal entity by assigning, re-assigning, or buying a domain name in existing domain zones in all variations of its spelling which is identical, similar in pronunciation or in writing, or close in meaning, to a field of economy, field of activity, products or services, for example, oil.com, gas.com, bank.com, newspaper.com, energy.com, toys.com (branch cybersquatting).

In the present invention, business method for domain name and trade mark assigning and marketing is performed by a person or legal entity by assigning, re-assigning, or buying a domain name in existing domain zones in all variations of its spelling which is identical, similar in pronunciation or in writing, or close in meaning, to a trade mark, brand, company name, personal name, or other means of individualization which are protected by law, foe example, sony.org, bmw.net (brand cybersquatting).

In the present invention, domain names which names are similar to promoted brands are registered for different purposes. Some place advertisements on web-sites, some create fishing traps. Others sell domain names to legal owners of brands, if the court decision is not in favor of the trade mark owner.

In the present invention, business method for domain name and trade mark assigning and marketing is performed by a person or legal entity by assigning, re-assigning, or buying a domain name in existing domain zones in all variations of its spelling which is identical, similar in pronunciation or in writing, or close in meaning, to a geographical name, foe example, a name of a city, town, country, part of the world, or any other geographical place or object, for example, london.net, paris.org, france.biz, asia.net, california.com (geographical cybersquatting).

In the present invention, business method for domain name and trade mark assigning and marketing is performed by a person or legal entity by assigning, re-assigning, or buying a domain name in existing domain zones in all variations of its spelling which is identical, similar in pronunciation or in writing, or close in meaning, to personal names, family names, or pseudonyms of persons, for example, PatriciaKaas.com, Putin.net, Ivanov.ru, John.com, Julia.com, Backham.net, Madonna.info (name cybersquatting).

In the present invention, business method for domain name and trade mark assigning and marketing is performed by a person or legal entity by assigning, re-assigning, or buying a domain name in existing domain zones in all variations of its spelling which is identical, similar in pronunciation or in writing, or close in meaning, to his own domain name, for example, the owner of a popular web-site <<www.firma.ru>> registers domains like firma-msk.ru, firma-spb.ru (protective cybersquatting).

In the present invention, in order to protect himself the domain name owner can either register similar domain names or register this domain name in all other domain zones, in order to minimize users' mistakes in entering the domain name or possibility of moving to web-sites that belong to other users and are similar in spelling or pronunciation (protective cybersquatting).

In the present invention, a legal owner of a famous web-site can register all domain names which are similar in pronunciation or in meaning to his own domain name. It is done in order to protect the domain name from competitors' and cybersquatters infringement, as well as to develop in future certain projects using the registered domain names. For example, several so called “negative” domain names like deathbypatch.com and orthoevrakills.com are registered to protect the new product of Ortho Evra Company. These domain names do not contain any web-sites, but they can not be used by competitors either (protective cybersquatting).

In the present invention, business method for domain name and trade mark assigning and marketing is performed by a person or legal entity by assigning of trade marks, brands, company names, or other person's or legal entity's attributes in all variations of its spelling which is identical, similar in pronunciation or in writing, or close in meaning, to his own trade mark, brand, company name, or other person's or legal entity's attributes (protective cybersquatting).

In the present invention, a legal owner of a domain name (popular web-site), or a trade mark, brand, company name, or other person's or legal entity's attributes, can register all domain names, or trade marks, brands, company names, or other person's or legal entity's attributes which are similar in pronunciation or spelling, close or related in meaning to his own domain name, or a trade mark, brand, company name, or other person's or legal entity's attributes, for example, the owner of the popular site www.user.com can register domains user-buziness.com, user-music.com, or user.org for visitors redirection from these web-sites to his main site, as well as anti-user.com, so that such site can not be used by competitors.

In the present invention, willing to protect the domain name, it is impossible to register all domains with letter combinations that are more or less close in meaning. The most promising ones should be selected. This is why cybersquatters choose domain names only after analysis of statistical databases of search queries has been performed. If new words or word combinations suddenly appear in these databases, or their use grows compared to the previous period, it means that this word, probably, will appear in popular domain zones, most likely, COM. As a rule, a name that appears in COM will soon be used in other domain zones (protective cybersquatting).

In the present invention, business method for domain name and trade mark assigning and marketing is performed by a person or legal entity by assigning, re-assigning, or buying domain names in all variations of their spelling which are identical, similar in pronunciation or in writing, or close in meaning, to names, trade marks, brands, company names, or other legal entity's attributes, for example, of banks and payment systems, and by creating temporary “false” web-sites in which names several Latin letters or symbols can be replaced with letters or symbols from other national alphabets, for example, the symbol “I” is replaced with the number “1”, or the combination of Latin letters “c” and “l” can be replaced with the letter “d”, for example, yanclex.ru instead of yandex.ru (fishing).

In the present invention, a fisher registers a domain name which is similar in writing to the domain name of, for example, a popular Internet-shop, then he copies the interface and design of the web-site and thus fools users, which gives him with easy access to passwords, credit card numbers, and other personal details of users' bank and payment systems, as well as participants of on-line games (fishing).

In the present invention, on average, such temporary “false” domain names and web-sites used for fishing do not exist for more than a week. Struggle against fishing costs much more, that is why registration of additional domain names to trade marks, brands, company names, and other person's or legal entity's attributes, is the right decision in business (fishing).

In the present invention, methods of protection from fishing which is a kind of network fraud, when users are decoyed to false web-sites which design copies the original web-site's design, and passwords and closed information are pumped out of them. In order to do it, fishers register domain names which coincide with famous companies' names, with some Latin letters being replaced with letters from national alphabets. Even before multilingual domain names appeared, fishers successfully fooled users by replacing the symbol “I” with the number “1”. For example, 2% of multilingual domain names in domain zones NET, COM are registered with mixed alphabets (fishing).

In the present invention, business method for domain name and trade mark assigning and marketing is performed by a person or legal entity by assigning, re-assigning, or buying domain names in all variations of their spelling or sounding which are identical, similar in pronunciation or in writing, or close in meaning, to popular domain names, web-sites, trade markes, brands, company names, or other person's or legal entity's attributes, and which are derived by changed letters or numbers, or mistakes in web-site's address' spelling, as well as presence or absence of a dot or hyphen in erroneous entering (human factor) of addresses by users, for example, instead of the addresses www.google.com, yandex.ru, rambler.ru or www.big-mir.ru, such erroneous addresses www.goofle.com, www.yamdex.ru, rabler.ru or www.bigmir.ru can be entered, or www is spelled in one word with the true name of a second level domain name, for example, wwwgoogle.com or wwwlenta.ru. For example, users forget to put dot after www when they hurry to enter a required address. Thus, strange web-sites with names like wwwbigmir.net appear, and they direct users anywhere, but not to the required web-site. Or a letter in a popular site's name is replaced with one which is next to it on the keyboard, which derives a lot of sites with familiar names, for example, http://Yansex.ru, http://Goofle.com, http://Ramvler.ru (typesquatting).

In the present invention, such domain names can differ from the object of “imitation” by one or two letters, or presence or absence of hyphen. Users often make a few unsuccessful attempts to enter URL in the browser, before they manage getting to the required site. This is due to the fact that a lot of company names or their domain names are difficult in spelling. There is great possibility of mistakes in entering such URL. Mistakes happen because of either wrong spelling of words, or mechanical spelling mistakes, for example, interchange of adjoining keys on the keyboard, double letters, or, on the contrary, missed letters.

In the present invention, persons or legal entities (typesquatters), which register similar domain names, have big traffic on these web sites due to users' mistakes in entering addresses in the browser. Thus, little known companies try to promote themselves with the help of the fact that: their names sound similar to famous and popular brands. For example, the brand <<Adidas>> has similar domain names like Abidas, Adidaas, Ericsson—Errison, Eriscon, and a famous in Britain publishing house <<Penguin Books>> has a similar in pronunciation domain name penquin.co.uk, which differs with only one letter <<q>> instead of <<g>>. Attracting large numbers of visitors to web-sites is the main goal of typesquatting.

In the present invention, such forged addresses are used for advertisement of products and services, or networks, for example, when entering addresses jandex.ru and yandeks.ru a user gets to the <<right>> web-site <<Yandex.ru>>, in the meanwhile looking through advertisements in appearing windows.

In the present invention, a lot of Internet companies (dotcoms) take preventive measures and register all possible versions of their domain names before they are registered by others.

In the present invention, typesquatting is very effective, when a similar brand is a popular trade mark. But it does not relate to general words which are not trademarks. For example, the domain name Download has similar domain names Downlaod.com, Donwload.com, and Dawnload.com, which were bought for 80,000 dollars, and this purchase, as the new owner thinks, is profitable investment, as far as these resources are visited by about 200 000 users a month. Thus, the main goal of typesquatting is profit from advertisement, for example, about 20% of typesquatters' sites contain banners and other advertisement.

In the present invention, in typesquatting it is very difficult to define the level of confusion of a “forged” domain name and a registered trademark. It is especially difficult, when such a “forged” domain name is used by its owner for doing legal business or non-commercial activity, for example, charity, which does not infringe upon owner's honor and dignity.

In the present invention, domain names which are similar in spelling are often used for compromising the “real” domain names. A user gets on such typesquatter's resource by mistake, and instead of expected useful information about this company or person who should have owned this web-site he/she finds a lot of compromising information there.

In the present invention, the main factors showing the growth of typesquatting popularity are a growing number of top level domain names, as well as a growing number of automated systems of domain name registration, when registrars do not see which names are being chosen by users.

In the present invention, another factor showing the growth of typesquatting popularity is an opportunity for hiding details of domain name owners in Whois service database, so that users can not know who the real owners of the domain name are.

In the present invention, another factor showing the growth of typesquatting popularity is an opportunity for free “testing” of the domain name in domain zones of public use, for example, during the period of 5 days. Only in case, when the domain name demonstrates big volumes of visits, the typesquatter registers it and places advertisement on it.

In the present invention, main characteristics of typesquatting are the following:
variations of spelling of the domain name, for example, ru-center/rucenter;
mistakes in spelling, for example, skoda/shkoda, commersant/kommersant, www.lenta.ru/wwwlenta.ru, nic.com/nik.com;
wrong use of top level domain name, for example, www.whitehouse.com/www.whitehouse.gov.
stable visits to twin-domain names, where advertisement is placed: carrying off of targeted audience, brand dilution.
Impossibility to buy domain names with mistakes back, because the advertisement placed there brings much more profit than their sale.

In the present invention, assigning or buying of domain names which are similar to other domain names allows the cybersquatter to detail real companies' or persons' addresses in the corresponding field of Whois database, thus having hindered third parties from opportunity to detect the place of his being. This is why typesquatting is a threat to the society, because it is a way of advertising in the Internet, and it can ruin business or reputation of a person, company, politician, party, governmental structure, for example, the web-site www.whitehouse.com (the real web-site of the White House is on www.whitehouse.gov).

In the present invention, business method for domain name and trade mark assigning and marketing is performed by a person or legal entity by assigning, re-assigning, or buying domain names which belong to other persons or legal entities, who are their legal owners, through providing registrars with forged documents showing their rights of ownership for these domain names (hijacking).

In the present invention, attention of the international Internet community is drawn by another problem under the name of domain name hijacking. Hijacking is illegal capture of registered domain names by providing registrartors with forged documents.

In the present invention, business method for domain name and trade mark assigning and marketing is performed by a person or legal entity by assigning, re-assigning, or buying of a number of domain names which contain certain trade marks, their parts, company names, or other person's or legal entity's attributes, in order to create networks of fraudulent web-sites, which period of existence is limited and does not exceed, for example, 1 month kaiting).

In the present invention, in kaiting, users forward their personal details to swindlers which act under famous domain names, and short-term existence of twin-sites brings huge losses to companies that own these trade marks.

In the present invention, business method for domain name and trade mark assigning and marketing is performed by service providers by assigning, re-assigning, or buying domain names through an anonymous proxy-server, and by providing additional Whois services on ensuring confidentiality of the person or company, which makes search for unconscientious domain name owners difficult when cases against them are raised in court. In this case, service providers that help cybersquatters to conceal their details become their accomplices.

1-29. (canceled)

30. A method for domain name and trademark creation and marketing, comprising:
creating (registering) a new person's or legal entity's attributes, which is identical, similar in pronunciation, in writing, or in other ways, up to complete confusion, to the existing person's or legal entity's attributes.

31. A method for domain name and trademark creation and marketing, comprising:
creating (registering) a new domain name in other top level domain zones which are the same as an existing domain name which has been registered in any one international or national top level domain zone.
